(19) United States
(12) Patent Application Publication
(10) Pub. No.: US 2026/0039698 A1
(43) Pub. Date: Feb. 5, 2026

(54) SECURITY POSTURE GENERATION USING AN ARTIFICIAL INTELLIGENCE (AI) MODEL

(71) Applicant: Google LLC, Mountain View, CA (US)

(72) Inventors: Kishore Kumar Garg, Ghaziabad (IN); Mukesh Kumar Marodia, Hyderabad (IN); Sneha Prasad, Bhagalpur (IN); Sudipta Das, Kolkata (IN); Varun Bhardwaj, Gurgaon (IN)

(21) Appl. No.: 18/789,397

(22) Filed: Jul. 30, 2024

(51) Int. Cl. H04L 9/40

(52) U.S. Cl. CPC H04L 63/20

(57) ABSTRACT

A system and method for exploring security rule chains in a security platform. The method includes providing a natural language description of a set of features of a security posture of an organization as a first input to a trained artificial intelligence (AI) model, providing telemetry data pertaining to a computing environment of the organization as a second input to the trained AI model, obtaining one or more outputs from the trained AI model, and extracting, from the one or more outputs, a set of generated features for the security posture of the organization.

### TECHNICAL FIELD

The present disclosure relates generally to cloud-based cybersecurity platforms. In particular, aspects and implementations of the present disclosure relate to security posture generation using artificial intelligence (AI) models.

### BACKGROUND

In today's digital age, organizations are constantly facing an increasing volume of sophisticated cybersecurity threats. Cybersecurity is the practice of protecting systems, networks, and data from digital attacks, unauthorized access, and damage.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

An aspect of the disclosure provides a computer-implemented method including: providing a natural language description of a set of desired features of a security posture of an organization as a first input to a trained artificial intelligence (AI) model; providing telemetry data pertaining to a computing environment of the organization as a second input to the trained AI model; obtaining one or more outputs from the trained AI model; and extracting, from the one or more outputs, a set of generated features for the security posture of the organization.

Aspects of the disclosure further include: determining whether the set of generated features satisfies a security threshold criterion; and responsive to determining the set of generated features satisfies the security threshold criterion, implementing the set of generated features in the computing environment of the organization.

Aspects of the disclosure further include wherein the security threshold criterion is based on a security specification, the method further including: determining whether the set of generated features satisfies a security threshold criterion; and responsive to determining that the set of generated features does not satisfy the external security specification, adding one or more additional features to the set of generated features.

Aspects of the disclosure further include: providing the set of generated features as an input to a second trained AI model; obtaining one or more outputs from the second trained AI model; and extracting from the one or more outputs, an indication of a validity of the set of generated features.

Aspects of the disclosure further include: providing the natural language description of the set of features of the security posture of the organization as a second input to the second trained AI model.

Aspects of the disclosure further include: causing a visual representation of the set of generated features to be visually rendered via a graphical user interface (GUI) associated with a prompt to confirm whether the set of generated features satisfy the security threshold criterion.

Aspects of the disclosure further include: determining whether the set of generated features satisfies a security threshold criterion; and responsive to determining the set of generated features does not satisfy the security threshold criterion, extracting, from the one or more outputs, a second set of generated features for the security posture of the organization.

An aspect of the disclosure provides for a system including a memory and one or more processing devices coupled with the memory, the one or more processing devices to perform operations including: providing a natural language description of a set of desired features of a security posture of an organization as a first input to a trained artificial intelligence (AI) model; providing telemetry data pertaining to a computing environment of the organization as a second input to the trained AI model; obtaining one or more outputs from the trained AI model; and extracting, from the one or more outputs, a set of generated features for the security posture of the organization.

Aspects of the disclosure further include: determining whether the set of generated features satisfies a security threshold criterion; and responsive to determining the set of generated features satisfies the security threshold criterion, implementing the set of generated features in the computing environment of the organization.

Aspects of the disclosure further include wherein the security threshold criterion is based on a security specification, the operations further including: determining whether the set of generated features satisfies a security threshold criterion; and responsive to determining that the set of generated features does not satisfy the external security specification, adding one or more additional features to the set of generated features.

Aspects of the disclosure further include: providing the set of generated features as an input to a second trained AI model; obtaining one or more outputs from the second trained AI model; and extracting from the one or more outputs, an indication of a validity of the set of generated features.

Aspects of the disclosure further include: providing the natural language description of the set of features of the security posture of the organization as a second input to the second trained AI model.

Aspects of the disclosure further include: causing a visual representation of the set of generated features to be visually rendered via a graphical user interface (GUI) associated with a prompt to confirm whether the set of generated features satisfy the security threshold criterion.

Aspects of the disclosure further include: determining whether the set of generated features satisfies a security threshold criterion; and responsive to determining the set of generated features does not satisfy the security threshold criterion, extracting, from the one or more outputs, a second set of generated features for the security posture of the organization.

An aspect of the disclosure provides a non-transitory computer readable storage medium including instructions for a server that, when executed by a processing device, cause the processing device to perform operations including: providing a natural language description of a set of desired features of a security posture of an organization as a first input to a trained artificial intelligence (AI) model; providing telemetry data pertaining to a computing environment of the organization as a second input to the trained AI model; obtaining one or more outputs from the trained AI model; and extracting, from the one or more outputs, a set of generated features for the security posture of the organization.

Aspects of the disclosure further include: determining whether the set of generated features satisfies a security threshold criterion; and responsive to determining the set of generated features satisfies the security threshold criterion, implementing the set of generated features in the computing environment of the organization.

Aspects of the disclosure further include wherein the security threshold criterion is based on a security specification, the operations further including: determining whether the set of generated features satisfies a security threshold criterion; and responsive to determining that the set of generated features does not satisfy the external security specification, adding one or more additional features to the set of generated features.

Aspects of the disclosure further include: providing the set of generated features as an input to a second trained AI model; obtaining one or more outputs from the second trained AI model; and extracting from the one or more outputs, an indication of a validity of the set of generated features.

Aspects of the disclosure further include: providing the natural language description of the set of features of the security posture of the organization as a second input to the second trained AI model.

Aspects of the disclosure further include: causing a visual representation of the set of generated features to be visually rendered via a graphical user interface (GUI) associated with a prompt to confirm whether the set of generated features satisfy the security threshold criterion.

Aspects of the disclosure further include: determining whether the set of generated features satisfies a security threshold criterion; and responsive to determining the set of generated features does not satisfy the security threshold criterion, extracting, from the one or more outputs, a second set of generated features for the security posture of the organization.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of a system architecture, according to aspects of the disclosure.

FIG. 2 is an illustrated diagram of an example system for security posture generation using an AI model, according to aspects of the disclosure.

FIG. 3 is an example block diagram of recommendation inputs that are used to generate the recommendation outputs by the security posture module, according to aspects of the disclosure.

FIG. 4 is an example block diagram of outputs from a security posture module, according to aspects of of the disclosure.

FIG. 5 illustrates an example block diagram flow for security posture generation using an AI model, according to aspects of the disclosure.

FIG. 6A illustrates an example method for security posture generation using an AI model, according to aspects of the disclosure.

FIG. 6B illustrates an example method for security posture generation using an AI model, according to aspects of the disclosure.

FIG. 7 is a block diagram illustrating an example of a computer system, according to aspects of the disclosure.

### DETAILED DESCRIPTION

Aspects of the present disclosure relate to security posture generation using an artificial intelligence (AI) model. A security posture can refer to an overall cybersecurity status of an organization's software, hardware, networking, services, information, and personnel. The security posture can be defined, e.g., by cybersecurity policies, parameters, producers, and controls implemented by the organization. The security posture can be implemented by a security platform. A security platform can serve one or more clients (e.g., represented by entities such as organizations).

The security platform can be part of an online (e.g., virtual) platform that provides clients with a comprehensive suite of productivity tools, programs, and services. The security platform can combine the features of a SIEM and a SOAR into a unified platform. The security platform collects log information from a client organization and provides the client organization with tools to detect, analyze, and respond to incidents described in the collected log information.

The security platform can provide a user (e.g., a systems administrator) from the client organization with a graphical user interface (GUI) to access, use, and configure the tools and functionality of the security platform that affect the security posture.

However, creating a security posture for an organization using a security platform can be a long, tedious, and recurring task. Sometimes, a poorly created security posture can cause more harm to an organization than if no security posture had been implemented. More effective security posture(s) may be based on current cybersecurity specifications or best practices and/or regulatory requirements. These specifications and requirements may change or evolve based on new attack vectors that are discovered or implemented by malicious actors, requiring a security posture of an organization to be updated regularly. Creating and updating a security posture for an organization can require a high level of knowledge about the organization, cybersecurity specifications and regulatory requirements, and security tools of the security platform. Additionally, creating and updating the security posture can require a high level of technical expertise. For example, in some instances, certain policies or procedures that are part of the security posture need to be translated from plain language into computer-executable code.

Organizations that lack the appropriate knowledge or technical expertise may implement inadequate security postures. An organization may not even realize that the security posture that has been implemented does not provide the protection that the organization intends the security posture to provide. For example, if a portion of a security posture is improperly represented in computer-executable code, the intended purpose of the portion of the security posture will not be performed. In a particular example, the organization may have intended to, for example, restrict access to an internal database, but due to poor implementation of the access restriction, the internal database may not be fully restricted.

Aspects of the present disclosure address these and other challenges by providing for security posture generation using an artificial intelligence (AI) model. A security intent of an organization can be described in natural language, and provided as input to the trained AI model. “Natural language” can refer to language that is commonly used in everyday spoken or written communication. The security intent can include details for how computing resources of the organization are to be managed and/or protected as part of the security posture. In some embodiments, a security intent can describe one or more of user access controls and/or policies, network security controls and/or policies, endpoint security controls and/or policies, data protection controls and/or policies, incident response and management controls and/or policies, or monitoring and assessment controls and/or policies. For example, a security intent describing user access controls may be reflected by the following natural language description: “Administrator user accounts should have access to databases X, Y, and Z, regular user accounts should have access to database Y, and user accounts associated with people who are managers should also have access to database A.” This description of a security intent describes the desired user access controls as well as data protection controls in natural language. In another example, a security intent can describe network security policies, such as limitations on the number of connected devices, the number of requests to process from a specific device over a certain time period, the type of data that can be transmitted across the network, available network ports or the like. In another example, a security intent can describe policies related to detecting malicious activity on endpoint devices, such as computers, smartphones, or the like.

In some embodiments, the natural language security intent can be provided to the security platform via an interactive graphical user interface (GUI). The AI model can convert the natural language security intent into a generated feature of a security posture. In some embodiments, the security platform implements the AI model. In some embodiments, the AI model can use generative AI techniques to convert the natural language security intent into computer-executable code. In some embodiments, the generative AI techniques can be implemented by a large language model (LLM).

In some embodiments, the AI model can identify cybersecurity specification(s) that are relevant to the natural language security intent. For example, the AI model can determine that the natural language security intent includes a requirement to restrict access to an internal database. Accordingly, the AI model can identify a cybersecurity specification that can be used to restrict access to internal databases. The AI model can utilize the cybersecurity specification to convert the natural language security intent into a generated feature of the security posture. In some embodiments, computer-executable code of security posture features can be pre-generated based on various cybersecurity specifications. For example, a particular cybersecurity specification may be periodically updated. Accordingly, the security platform can obtain the periodic revisions and generate (or re-generate) security posture features that comply with the most recent revision of the particular cybersecurity specification. In some embodiments, the identified cybersecurity specification can be a proprietary standard. In some embodiments, the identified cybersecurity specification can be an open-source standard.

Advantages of implementing security posture generation using an AI model include improving security postures of organizations with less-sophisticated cybersecurity personnel or procedures, a reduction in time and effort to create or update a security posture, and an improved configurability of security postures particularly on-the-fly. These improvements can lead to an overall improved cybersecurity of the computing environment of the client organization through improved functionality of security platform tools and features available to clients.

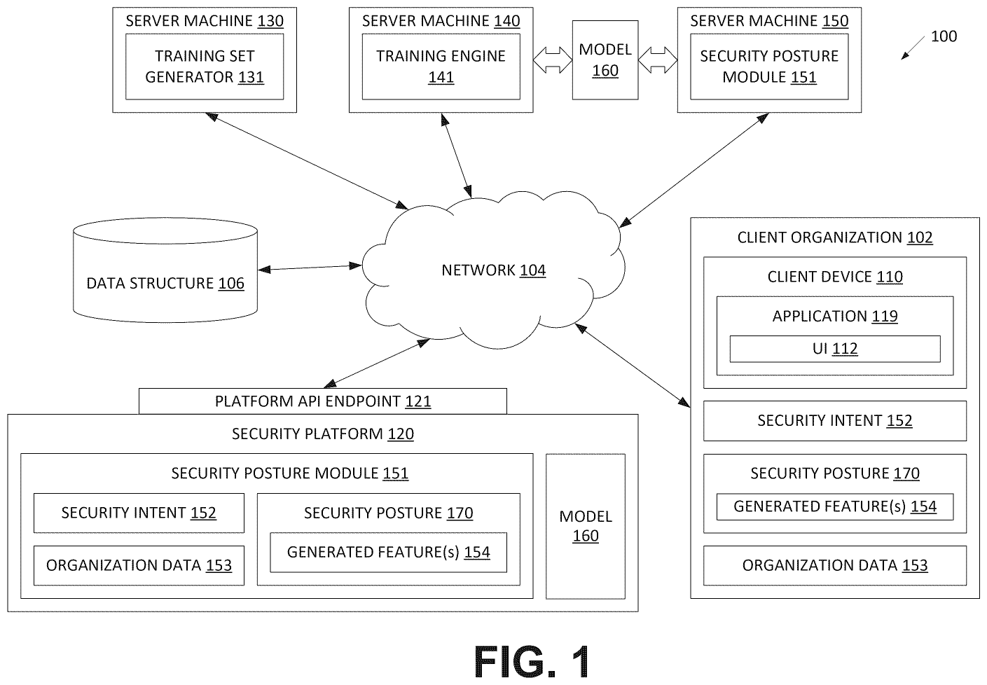

FIG. 1 illustrates an example of a system 100, in accordance with aspects of the disclosure. The system 100 includes a security platform 120, one or more server machines 130-150, a data structure 106, and client device 110 of a client organization 102 connected to network 104.

In some embodiments, network 104 can include a public network (e.g., the Internet), a private network (e.g., a local area network (LAN) or wide area network (WAN)), a wired network (e.g., Ethernet network), a wireless network (e.g., an 802.11 network or a wireless fidelity (Wi-Fi) network), a cellular network (e.g., a Long Term Evolution (LTE) network), routers, hubs, switches, server computers, and/or a combination thereof.

Data structure 106 can be a persistent storage that is capable of storing data such as log information (e.g., sequences of characters in a log), labels reflecting a type of log, and the like. Data structure 106 can be hosted by one or more storage devices, such as main memory, magnetic or optical storage based disks, tapes or hard drives, network-attached storage (NAS), storage area network (SAN), and so forth. In some embodiments, data structure 106 can be a network-attached file server, while in other embodiments the data structure 106 can be another type of persistent storage such as an object-oriented database, a relational database, and so forth, that can be hosted by security platform 120, or one or more different machines coupled to the server hosting the security platform 120 via the network 104. In some embodiments, data structure 106 can be capable of storing one or more data items, as well as data structures to tag, organize, and index the data items. A data item can include various types of data including structured data, unstructured data, vectorized data, etc., or types of digital files, including text data, audio data, image data, video data, multimedia, interactive media, data objects, and/or any suitable type of digital resource, among other types of data. An example of a data item can include a file, database record, database entry, programming code or document, among others.

The client organization 102 can be an organization that is using one or more services of the security platform 120. For example, the client organization 102 can have one or more features of a security posture generated (e.g., generated feature(s) 154) by the security platform 120. In some embodiments, the client organization 102 can include one or more client devices 110. The client device 110 can each include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some embodiments, client devices 110 can be one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components. In some embodiments, client device(s) may also be referred to as a “user device” herein. Although a single client device 110 is shown for purposes of illustration rather than limitation, one or more client devices can be implemented in some embodiments. Client device 110 will be referred to as client device 110 or client devices 110 interchangeably herein.

In some embodiments, a client device, such as client device 110, can implement or include one or more applications. In some embodiments, application 119 can be used to communicate (e.g., send and receive information) with the security platform 120. In some embodiments, application 119 can implement user interfaces (UIs) (e.g., graphical user interfaces (GUIs)), such as a user interface (UI) (e.g., UI 112) that may be webpages rendered by a web browser and displayed on the client device 110 in a web browser window. In another embodiment, the UIs 112 of client application, such as application 119 may be included in a stand-alone application downloaded to the client device 110 and natively running on the client device 110 (also referred to as a “native application” or “native client application” herein). In some embodiments, security posture module 151 can be implemented as part of application 119. In other embodiments, security posture module 151 can be separate from application 119 and application 119 can interface with security posture module 151.

In some embodiments, one or more client devices 110 can be connected to the system 100. In some embodiments, client devices, under direction of the security platform 120 when connected, can present (e.g., display) a UI 112 to a user of a respective client device through application 119. The client devices 110 may also collect input from users through input features.

In some embodiments, a UI 112 may include various visual elements (e.g., UI elements) and regions, and can be a mechanism by which the user engages with the security platform 120, and system 100 at large. In some embodiments, the UI 112 of a client device 110 can include multiple visual elements and regions that enable presentation of information, for decision-making, content delivery, etc. at a client device 110. In some embodiments, the UI 112 may sometimes be referred to as a graphical user interface (GUI)).

In some embodiments, the UI 112 and/or client device 110 can include input features to intake information from a client device 110. In one or more examples, a user of client device 110 can provide input data (e.g., a user query, control commands, etc.) into an input feature of the UI 112 or client device 110, for transmission to the security platform 120, and system 100 at large. Input features of UI 112 and/or client device 110 can include space, regions, or elements of the UI 112 that accept user inputs. For example, input features may include visual elements (e.g., GUI elements) such as buttons, text-entry spaces, selection lists, drop-down lists, etc. For example, in some embodiments, input features may include a chat box which a user of client device 110 can use to input textual data (e.g., a user query). The application 119 via client device 110 can then transmit that textual data to security platform 120, and the system 100 at large, for further processing. In other examples, input features can include a selection list, in which a user of client device 110 can input selection data e.g., by selecting, or clicking. The application 119 via client device 110 can then transmit that selection data to security platform 120, and the system 100 at large, for further processing.

In some embodiments, a client device 110 can access the security platform 120 through network 104 using one or more application programming interface (API) calls via platform API endpoint 121. In some embodiments, security platform 120 can include multiple platform API endpoints 121 that can expose services, functionality, or information of the security platform 120 to one or more client devices 110. In some embodiments, a platform API endpoint 121 can be one end of a communication channel, where the other end can be another system, such as a client device 110 associated with a user account. In some embodiments, the platform API endpoint 121 can include or be accessed using a resource locator, such a universal resource identifier (URI), universal resource locator (URL), of a server or service. The platform API endpoint 121 can receive requests from other systems, and in some cases, return a response with information responsive to the request. In some embodiments, HTTP (Hypertext Transfer Protocol), HTTPS (Hypertext Transfer Protocol Secure) methods (e.g., API calls) can be used to communicate to and from the platform API endpoint 121.

In some embodiments, the platform API endpoint 121 can function as a computer interface through which access requests are received and/or created. In some embodiments, the platform API endpoint 121 can include a platform API whereby external entities or systems can request access to services and/or information provided by the security platform 120. The platform API can be used to programmatically obtain services and/or information associated with a request for services and/or information.

In some embodiments, the API of the platform API endpoint 121 can be any suitable type of API such as a REST (Representational State Transfer) API, a GraphQL API, a SOAP (Simple Object Access Protocol) API, and/or any suitable type of API. In some embodiments, the security platform 120 can expose through the API, a set of API resources which when addressed can be used for requesting different actions, inspecting state or data, and/or otherwise interacting with the security platform 120. In some embodiments, a REST API and/or another type of API can work according to an application layer request and response model. An application layer request and response model can use HTTP, HTTPS, SPDY, or any suitable application layer protocol. Herein HTTP-based protocol is described for purposes of illustration, rather than limitation. The disclosure should not be interpreted as being limited to the HTTP protocol. HTTP requests (or any suitable request communication) to the security platform 120 can observe the principals of a RESTful design or the protocol of the type of API. RESTful is understood in this document to describe a Representational State Transfer architecture. The RESTful HTTP requests can be stateless, thus each message communicated contains all necessary information for processing the request and generating a response. The platform API can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

It can be appreciated that in some embodiments, any element, such as server machine 130, server machine 140, server machine 150, and/or data structure 106 may include a corresponding API endpoint for communicating with APIs.

In some embodiments, the security platform 120 may include one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to data or services. Such computing devices can be positioned in a single location or can be distributed among many different geographical locations. For example, security platform 120 can include a plurality of computing devices that together may comprise a hosted computing resource, a grid computing resource, or any other distributed computing arrangement. In some embodiments, the security platform 120 can correspond to an elastic computing resource where the allotted capacity of processing, network, storage, or other computing-related resources may vary over time.

In some embodiments, the security platform 120 can provide tools for the client organization 102 to obtain generated features 154 for a security posture 170 based on a security intent 152 and/or organization data 153. A generated feature 154 can include machine readable instructions (e.g., computer code) that enables one or more of user access controls, network security settings, endpoint security settings, data protection controls, incident response and management controls, monitoring and assessment controls, or the like as part of a security posture 170. For example, a generated feature 154 can reflect machine readable instructions that, when executed, implement user access controls for a database. In some embodiments, the security posture module 151 can obtain the security intent 152, and provide the security intent 152 as input to the model 160. The security posture module 151 can obtain a generated feature 154 as output from the model 160, based on the security intent 152. In some embodiments, the security posture module 151 can implement the generated feature 154 in the security posture 170.

The security platform 120 can include a security posture module 151. In some embodiments, the security posture module 151 can manage a security posture 170 for the organization. In some embodiments, the security posture module 151 can receive a security intent 152 from the client organization 102. The security posture module 151 can use the model 160 to obtain a generated feature 154 based on the security intent 152.

The security intent 152 can be obtained from the client organization 102 via a GUI, such as UI 112 of application 119. In some embodiments, the security intent 152 can be expressed in natural language. In some embodiments, the security intent 152 defines desired outcomes of a security posture feature (e.g., the generated feature 154). For example, the security intent 152 can include guiding principles for how a generated feature 154 should be generated based on the security intent. For example, the security intent 152 can recite: “Provide a feature of the security posture that protects an organization database. The format of the feature output should be in YAML. The feature can be preventative and detective in nature,” (where ‘preventative’ and ‘detective’ refers to the ‘guiding principle’ for the security intent 152). A corresponding generated feature 154 may be generated that ‘prevents’ external users from accessing the organization database, and ‘detects’ when an unauthorized access of the database occurs. In another example, the security intent 152 can include textual descriptions of specific policies or procedures to safeguard information assets, ensure data integrity, and protect against cybersecurity threats. For example, the security intent can recite: “Provide a feature for implementing user account access management of Database A that complies with the current Center for Internet Security (CIS) best practices and that is compatible with the National Institute of Standards and Technology (NIST) Cybersecurity Framework (CSF).” A corresponding generated feature 154 may be generated that enables the client organization to control user account access to the database A, and complies with CIS best practices and the NIST CSF.

In some embodiments, the security posture module 151 can obtain a generated feature 154 as an output from the model 160 based on the security intent 152 and organization data 153. Organization data 153 can include one or more of telemetry data from the client (e.g., application log files, network traffic metadata, etc.) client organization security posture information (e.g., specific policies from the security posture, expressed in natural language, or machine-readable instructions), organization asset information (e.g., physical devices such as computers, network routing equipment, servers, etc.), organization or security platform security findings (e.g., identification of and/or remedial actions performed for malicious activities), security platform-suggested security posture or configuration information (e.g., default configuration settings from the security platform, or configuration settings the security platform observes many client organizations implement), security hash algorithm information, regulation compliance information, or the like. For example, the current security posture of the client organization can be evaluated by the model 160 in light of the security intent 152 to determine whether the current security posture satisfies some or all of the security intent 152. In another example, network or computing infrastructure information, such as system logs, can be used by the model 160 to produce the generated feature 154. In another example, the security platform 120 can provide a default or suggested security posture, and/or one or more policies or configurations. The security platform 120 can obtain policy and configuration information from multiple client organizations that use the security platform 120 and identify commonalities between the configuration information for each client organization. For example, if 90% of client organizations that use the security platform 120 use the same user account password policies, the security platform 120 can provide the user account password policy as a suggested policy to the client organization 102. In a particular example, a financial institution that uses the security platform 120 (e.g., a client organization 102) may have certain configurations or features in a security posture. Another financial institution that uses the security platform 120 may have similar requirements for a security posture, which can be provided as suggestions by the security platform 120. In another example, privacy regulation information, such as the California Consumer Privacy Act (CCPA) or portions of the CCPA can be provided as a textual input to the model 160 to obtain a generated feature 154 as output from the model that complies with the privacy regulation information. In some embodiments, the model 160 is a LLM, which can process textual input(s) and generate a textual output based on the textual input(s).

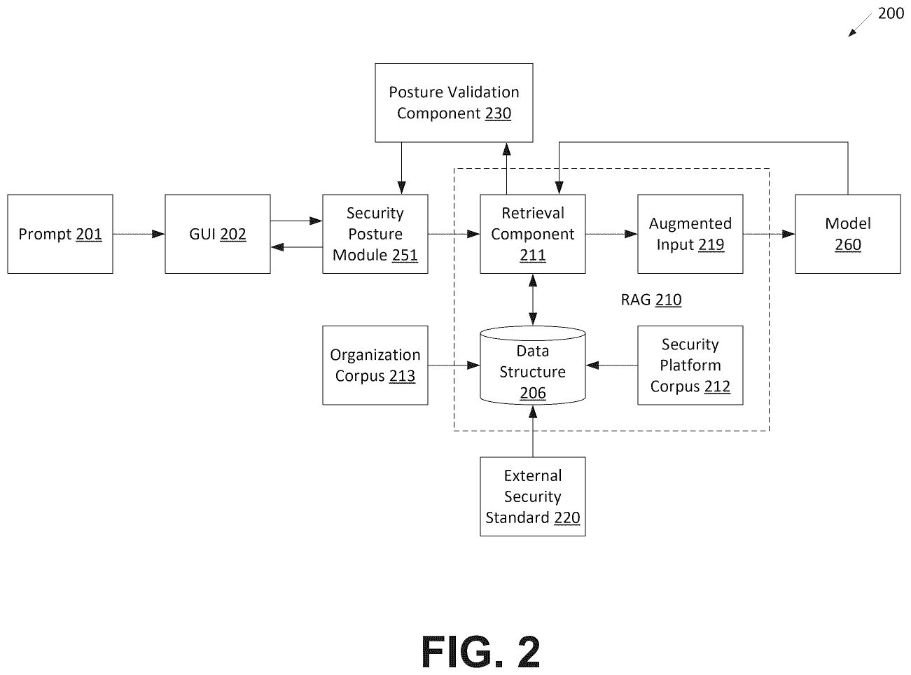

In some embodiments, the security posture module 151 can use retrieval augmented generation (RAG) techniques on organization data 153 of the client organization 102 to supplement the inputs to the model 160. The query is used to retrieve relevant documents or information from a database, such as data structure 106. The documents or information can be selected based on relevance to the initial query. Relevance can be determined by semantic search or similarity matching. The retrieved information (e.g., the documents and/or information) can be combined with the initial query to create an enhanced prompt. This enriched input is provided as input to the model 160. In some embodiments, the model 160 is a generative model, i.e., the enriched input is provided as input to a generative model. In this way, RAG techniques can enable the model 160 to produce more accurate or contextually aware responses (as informed by the retrieved documents and/or information). Additional details regarding use of RAG by the security posture module 151 are described below with reference to FIG. 2.

The model 160 can generate one or more outputs based on the various inputs described above. In some embodiments, the generated feature 154 can be extracted from the one or more outputs. In some embodiments, the generated feature 154 can reflect computer-executable code. In some embodiments, the generated feature 154 can be reflected in human-readable data serialization language, such as YAML Ain′t Markup Language (YAML).

In some embodiments, the security posture module 151 can perform one or more verification operations on the generated feature 154. For example and in some embodiments, the security posture module 151 can execute the computer-executable code that is contained in the generated output (e.g., a generated feature 154). If the computer-executable code does not function as desired, the generated feature 154 does not satisfy the verification criterion. In another example and in some embodiments, the security posture module 151 can use the generated feature 154 as input to the model 160 along with an additional input indicating that the model 160 is to verify the syntax of the generated feature 154. If the generated feature 154 has proper syntax for a given computer-executable code language or specification, the generated feature 154 can satisfy a verification criterion.

In some embodiments, security platform 120 may generate, modify, and monitor the client-side UIs (e.g., graphical user interfaces (GUI)) and associated components that are presented to users of the security platform 120 through UI 112 client devices 110. For example, security posture module 151 can generate the UIs (e.g., UI 112 of client device 110) that users interact with while engaging with the security platform 120.

In some embodiments, a machine learning model (e.g., also referred to as an “artificial intelligence (AI) model” herein) can include a discriminative machine learning model (also referred to as “discriminative AI model” herein), a generative machine learning model (also referred to as “generative AI model” herein), and/or other machine learning model.

In some embodiments, a discriminative AI model can model a conditional probability of an output for given input(s). A discriminative AI model can learn the boundaries between different classes of data to make predictions on new data. In some embodiments, a discriminative AI model can include a classification model that is designed for classification tasks, such as learning decision boundaries between different classes of data and classifying input data into a particular classification. Examples of discriminative AI models include, but are not limited to, support vector machines (SVM) and neural networks.

In some embodiments, a generative AI model learns how the input training data is generated and can generate new data (e.g., original data). A generative AI model can model the probability distribution (e.g., joint probability distribution) of a dataset and generate new samples that often resemble the training data. Generative AI models can be used for tasks involving image generation, text generation and/or data syn-thesis. Generative AI models include, but are not limited to, gaussian mixture models (GMMs), variational autoencoders (VAEs), generative adversarial networks (GANs), large language models (LLMs), vision-language models (VLMs), multi-modal models (e.g., text, images, video, audio, depth, physiological signals, etc.), and so forth.

Server machine 130 includes a training set generator 131 that is capable of generating training data (e.g., a set of training inputs and a set of target outputs) to train a model 160 (e.g., a discriminative machine learning model). In some embodiments, training set generator 131 can generate the training data based on various data (e.g., stored at data structure 106 or another data structure connected to system 100 via the network 104). The data structure 106 can store metadata associated with the training data.

Server machine 140 includes a training engine 141 that is capable of training a model 160 using the training data from training set generator 131. The model 160 (also referred to “machine learning model” or “artificial intelligence (AI) model” herein) may refer to the model artifact that is created by the training engine 141 using the training data that includes training inputs (e.g., features) and corresponding target outputs (correct answers for respective training inputs) (e.g., labels). The training engine 141 may find patterns in the training data that map the training input to the target output (the answer to be predicted) and provide the model 160 that captures these patterns. The model 160 may be composed of, e.g., a single level of linear or non-linear operations (e.g., a support vector machine (SVM), or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. Model 160 can use one or more of a support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc. For convenience rather than limitation, the remainder of this disclosure describing a discriminative machine learning model will refer to the implementation as a neural network, even though some implementations might employ other types of learning machine instead of, or in addition to, a neural network.

In some embodiments, such as with a supervised machine learning model, the one or more training inputs of the set of the training inputs are paired with respective one or more training outputs of the set of training outputs. The training input-output pair(s) can be used as input to the machine learning model to help train the machine learning model to determine, for example, patterns in the data.

In some embodiments, the model 160 can be a generative AI model. A generative AI model is an AI model which can generate new, original data. A model 160 can include a generative adversarial network (GAN) and/or a variational autoencoder (VAE). In some instances, a GAN, a VAE, and/or other types of generative AI models can employ different approaches to training and/or learning the underlying probability distributions of training data, compared to some AI models.

For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

In some embodiments, the model 160 can be a generative large language model (LLM).

In some embodiments, the model 160 can be a large language model that has been pre-trained on a large corpus of data so as to process, analyze, and generate human-like text based on given input.

In some embodiments, the model 160 may have any architecture for LLMs, including one or more architectures as seen in Generative Pre-trained Transformer (GPT) series (Chat GPT series LLMs), Google's Gemini®, or LaMDA, or leverage a combination of transformer architecture with pre-trained data to create coherent and contextually relevant text.

In some embodiments, a model 160, such as an LLM, can use an encoder-decoder architecture including one or more self-attention mechanisms, and one or more feed-forward mechanisms. In some embodiments, the model 160 can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A model 160 can also utilize the previously discussed deep learning techniques, including recurrent neural networks (RNNs), convolutional neural networks (CNNs), or transformer networks.

In some embodiments, the model 160 can be a multi-modal generative AI model, such as a Visual-Language Model (VLM). In some embodiments, the model 160 can be a VLM that has been pre-trained on a large corpus of data (e.g., textual data and image data) so as to process, analyze, and generate human-like text and/or image data based on given input (e.g., image data and/or natural language text).

In some embodiments, training a generative AI model can include providing training input to a model 160, and the model 160 can produce one or more training outputs. The one or more training inputs can be compared to one or more evaluation metrics. An evaluation metric can refer to a measure used to assess the output (e.g., training output(s)) of a AI model, such as a model 160. In some embodiments, the evaluation metric can be specific to the task and/or goals of the AI model. Based on the comparison, one or more parameters and/or weights of the model 160 can be adjusted (e.g., backpropagation based on computed loss). In some embodiments, and for example, the one or more training outputs can be compared to an evaluation metric such as a ground truth (e.g., target output, such as a correct or better answer). In some embodiments and for example, the one or more training outputs can be evaluated/compared to an evaluation metric and can be rewarded (e.g., evaluated as a positive answer) or penalized (e.g., evaluated as a negative answer) based on the quality of the one or more training outputs (e.g., reinforcement learning).

In some embodiments, a validation engine (not shown) may be capable of validating a model 160 using a corresponding set of features of a validation set from the training set generator. In some embodiments, the validation engine may determine an accuracy of each of the trained generative models, such as model 160 (e.g., accuracy of the training output) based on the corresponding sets of features of the validation set. The validation engine may discard a trained model 160 that has an accuracy that does not meet a threshold accuracy. In some embodiments, a selection engine not shown) may be capable of selecting a model 160 that has an accuracy that meets a threshold accuracy. In some embodiments, the selection engine may be capable of selecting the trained model 160 that has the highest accuracy of the trained generative models (e.g., model 160).

A testing engine (not shown) may be capable of testing a trained model 160 using a corresponding set of features of a testing set from the training engine 141. For example, a first trained model 160 that was trained using a first set of features of the training set may be tested using the first set of features of the testing set. The testing engine may determine a trained model 160 that has the highest accuracy of all of the trained AI models based on the testing sets.

In some embodiments, a model 160 can be trained on a corpus of data, such textual data and/or image data. In some embodiments, the model 160 can be a model that is first pre-trained on a corpus of text to create a foundational model (e.g., also referred to as “pre-trained model” herein), and afterwards adapted (e.g., fine-tuned or transfer learning) on more data pertaining to a particular set of tasks to create a more task-specific or targeted generative AI model (e.g., also referred as an “adapted model” herein.) The foundational model can first be pre-trained using a corpus of data (e.g., text and/or images) that can include text and/or image content in the public domain, licensed content, and/or proprietary content (e.g., proprietary organizational data). The model 160 can use pre-training to learn broad image elements and/or broad language elements including general sentence structure, common phrases, vocabulary, natural language structure, and any other elements commonly associated with natural language in a large corpus of text. In example, the pre-trained model can be fine-tuned to the specific task or domain that the model 160 is to be adapted. In some embodiments, model 160 may include one or more pre-trained models or adapted models.

In some embodiments, training data, such as training input and/or training output, and/or input data to a trained machine learning model (collectively referred to as “machine learning model data” herein) can be preprocessed before providing the aforementioned data to the (trained or untrained) machine learning model (e.g., discriminative machine learning model and/or generative machine learning model) for execution. Preprocessing as applied to machine learning models (e.g., discriminative machine learning model and/or generative machine learning model) can refer to the preparation and/or transformation of machine learning model data.

In some embodiments, preprocessing can include data scaling. Data scaling can include a process of transforming numerical features in raw machine learning model data such that the preprocessed machine learning model data has a similar scale or range. For example, Min-Max scaling (Normalization) and/or Z-score normalization (Standardization) can be used to scale the raw machine learning model. For instance, if the raw machine learning model data includes a feature representing temperatures in Fahrenheit, the raw machine learning model data can be scaled to a range of [0, 1] using Min-Max scaling.

In some embodiments, preprocessing can include data encoding. Encoding data can include a process of converting categorical or text data into a numerical format on which a machine learning model can efficiently execute. Categorical data (e.g., qualitative data) can refer to a type of data that represents categories and can be used to group items or observations into distinct, non-numeric classes or levels. Categorical data can describe qualities or characteristics that can be divided into distinct categories, but often does not have a natural numerical meaning. For example, colors such as red, green, and blue can be considered categorical data (e.g., nominal categorical data with no inherent ranking). In another example, “small,” “medium,” and “large” can be considered categorical data (ordinal categorical data with an inherent ranking or order). An example of encoding can include encoding a size feature with categories [“small,” “medium,” “large”] by assigning 0 to “small,” 1 to “medium,” and 2 to “large.”

In some embodiments, preprocessing can include data embedding. Data embedding can include an operation of representing original data in a different space, often of reduced dimensionality (e.g., dimensionality reduction), while preserving relevant information and patterns of the original data (e.g., lower-dimensional representation of higher-dimensional data). The data embedding operation can transform the original data so that the embedding data retains relevant characteristics of the original data and is more amenable for analysis and processing by machine learning models. In some embodiments embedding data can represent original data (e.g., word, phrase, document, or entity) as a vector in vector space, such as continuous vector space. Each element (e.g., dimension) of the vector can correspond to a feature or property of the original data (e.g., object). In some embodiments, the size of the embedding vector (e.g., embedding dimension) can be adjusted during model training. In some embodiments, the embedding dimension can be fixed to help facilitate analysis and processing of data by machine learning models.

In some embodiments, the training set is obtained from server machine 130. Server machine 150 includes a security posture module 151 that provides current data (e.g., log information, etc.) as input to the trained machine learning model (e.g., model 160) and runs the trained machine learning model (e.g., model 160) on the input to obtain one or more outputs.

In some embodiments, the training set (or fine-tuning training set) can include training inputs reflecting security posture information obtained by the security platform 120 from the client organizations 102 that use the security platform 120. In some embodiments, the security posture information can include usage data (e.g., how a client organization 102 uses the security platform 120, configuration settings, etc.), information about the client organization 102 (e.g., an industry, a real or estimated technical sophistication of the organization, etc.), information or configuration settings provided or suggested by the security platform 120, or the like. In some embodiments, the training set can include training outputs reflecting machine-readable instructions that correspond to the training inputs. In some embodiments, the training inputs can be paired to the training outputs. For example, the training input can indicate the values of certain configuration settings, and the paired training output can reflect machine-readable instructions that when executed, set the values of configuration settings to the values received in the training input. In some embodiments, the training inputs can be generated (by another process, system or AI model) for specific training, or target outputs. For example, a target output that reflects machine-readable instructions that when executed, set configuration settings to certain values can have a training input generated that describes the output in natural language. In a particular example, a paired training input can be created by a system, process, or other model (e.g., such as a human evaluator), “General user accounts have limited access permissions, and are restricted to databases A and B. Administrator user accounts do not have limited access permissions and can access databases A, B, and C.” This training input can be paired with the target output (which reflects machine-readable instructions that when executed, set the access permissions for user accounts), and used in the training set to train, or fine-tune the model 160.

In some embodiments, the model 160 can generate confidence data. Confidence data can include or indicate a level of confidence that a particular output (e.g., output(s)) corresponds to one or more inputs of the machine learning model (e.g., trained machine learning model). In one example, the level of confidence is a real number between 0 and 1 inclusive, where 0 indicates no confidence that output(s) corresponds to a particular one or more inputs and 1 indicates absolute confidence that the output(s) corresponds to a particular one or more inputs. In some embodiments, confidence data can be associated with inference using a machine learning model.

In some embodiments, a machine learning model, such as model 160, may be (or may correspond to) one or more computer programs executed by processor(s) of server machine 140 and/or server machine 150. In other embodiments, a machine learning model may be (or may correspond to) one or more computer programs executed across a number or combination of server machines. For example, in some embodiments, machine learning models may be hosted on the cloud, while in other embodiments, these machine learning models may be hosted and perform operations using the hardware of a client device 110. In some embodiments, the machine learning models may be a self-hosted machine learning model, while in other embodiments, machine learning models may be external machine learning models accessed by an API.

In some embodiments, server machines 130 through 150 can be one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to one or more data items of the security platform 120. The security platform 120 can also include a website (e.g., a webpage) or application back-end software that can be used to provide users with access to the security platform 120.

In some embodiments, one or more of server machine 130, server machine 140, model 160, server machine 150 can be part of security platform 120. In other embodiments, one or more of server machine 130, server machine 140, server machine 150, or model 160 can be separate from security platform 120 (e.g., provided by a third-party service provider).

Also as noted above, for purposes of illustration, rather than limitation, aspects of the disclosure describe the training of a machine learning model (e.g., model 160) and use of a trained machine learning model (e.g., model 160). In other embodiments, a heuristic model or rule-based model can be used as an alternative. It should be noted that in some other embodiments, one or more of the functions of security platform 120 can be provided by a greater number of machines. In addition, the functionality attributed to a particular component of the security platform 120 can be performed by different or multiple components operating together. Although embodiments of the disclosure are discussed in terms of security platforms, embodiments can also be generally applied to any type of platform or service.

In general, functions described in implementations as being performed by security platform 120, client organization 102, and/or server machine 140 can also be performed on the client device 110 in other implementations, if appropriate. In addition, the functionality attributed to a specific component can be performed by different or multiple components operating together. The security platform 120 can also be accessed as a service provided to other systems or devices through appropriate application programming interfaces, and thus is not limited to use in websites.

In implementations of the disclosure, a “user” can be represented as a single individual. For example, a user of the client device 110. However, other implementations of the disclosure encompass a “user” being an entity controlled by a set of users and/or an automated source (e.g., client organization 102). For example, a set of individual users federated as a community in a social network can be considered a “user.” In another example, an automated consumer can be an automated ingestion pipeline of security platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a specific location of a user cannot be determined. Thus, the user can have control over what information is collected about the user, how that information is used, and what information is provided to the user.

FIG. 2 is an illustrated diagram of an example system 200 for security posture generation using an AI model, according to aspects of the disclosure. The system 200 includes a security posture module 251. A prompt 201 is provided via a GUI 202 to the security posture module 251. The security posture module 251 uses RAG 210 to provide an augmented input 219 to the model 260. RAG 210 can be performed by a retrieval component 211 that accesses a data structure 206. The data structure 206 can be populated with security platform corpus 212, organization corpus 213, and external security specifications 220. The retrieval component 211 obtains an output from the model 260 and provides the output from the model 260 to the posture validation component 230. Once the posture validation component 230 has validated the output from the model 260, it is provided to the security posture module 251. The security posture module 251 causes the output from the model 260 to be visually rendered by the GUI 202.

In some embodiments, the prompt 201 represents a security intent of an organization (e.g., the security intent 152 of FIG. 1). As described above, the security intent can include details for how computing resources of the organization are to be managed and/or protected. In some embodiments, the prompt 201 is represented in natural language. As described above, natural language can refer to language that is commonly used in spoken or written communication. In some embodiments, the prompt 201 can include additional technical details (in a textual description) about the security intent, system or organization resources, or the like. In some embodiments, the prompt 201 can reference an external security specification. For example, the prompt 201 can reference an open-source privacy specification that may or may not be represented in the data structure 206 as an external security specification 220. In embodiments where the referenced external security specification is not represented in the data structure 206, in some embodiments, the security posture module 251 can cause publicly accessible databases to be queried in order to obtain the referenced external security specification that is not represented in the data structure 206. In some embodiments, if the security posture module 251 is unable to obtain the referenced external security specification, the remaining portions of the prompt 201 can be processed. In some embodiments, the security posture module 251 can indicate via the GUI 202 that the external security specification was unavailable, or otherwise not used as input to the model 260.

In some embodiments, the GUI 202 can be the same as, or similar to the UI 112 element described above with reference to FIG. 1. The GUI 202 can visually render an interface with which users of the client organization can interact with the security posture module 251. In some embodiments, the GUI 202 can present a user with a prompt graphical element, which accepts the prompt 201 as input. In some embodiments, the GUI 202 can present the user with an output graphical element, which presents the output from the model 260, as received from the posture validation component 230. In some embodiments, some elements of the GUI 202 are arranged and/or rendered locally, on a client device. In some embodiments, some elements of the GUI 202 are arranged and/or rendered on a server, and transmitted to the client device.

The security posture module 251 can be the same as, or similar to the security posture module 151 as described above with reference to FIG. 1. In some embodiments, the security posture module 251 receives a prompt 201, and provides a generated feature (e.g., an output from the model 260) based on the prompt 201. In some embodiments, the security posture module 251 can provide several different generated features based on a prompt 201. In some embodiments, the security posture module 251 can provide several variations of the same generated feature based on a prompt 201.

The retrieval component 211 can perform a RAG technique as described above (e.g., RAG 210). In some embodiments, the retrieval component 211 generates an augmented input based on data in the data structure 206. In some embodiments, the retrieval component 211 can initiate a retrieval of data (e.g., security platform corpus 212, organization corpus 213, external security specification 220, etc.) from respective data sources (e.g., from an internal security platform data structure, an organization data structure, an external security specification data structure, etc.). In some embodiments, the retrieval component 211 can generate (or cause to be generated) condensed representations of data provided to the data structure. For example, the retrieval component 211 can use a large language model (LLM) on security platform corpus 212 to generate a condensed security platform corpus. In some embodiments, the condensed corpus can be generated as the original corpus is retrieved from the data structure 206. That is, the retrieval process initiated by the retrieval component 211 can condense a corpus that is stored on the data structure 206. In some embodiments, the condensed corpus can be what is actually stored in the data structure 206, and the original corpus, for example, the security platform corpus 212, can be processed by the LLM (or related summarization techniques) when a representation of the original corpus is to be stored in the data structure 206.

In some embodiments, the retrieval component 211 can organize data retrieved from the data structure 206 into a format that is compatible with the prompt 201. In some embodiments, the data retrieved from the data structure 206 can be represented as one or more tokens, words, letters, numbers, symbols, or the like. The retrieval component 211 can use one or more tokens, words, letters, numbers, symbols, or the like that are provided in the prompt 201 to perform the RAG 210. Additional data from the data structure 206 can be added to the prompt 201 to generate the augmented input 219. In some embodiments, the data from the data structure 206 can be added he augmented input 219 based on a similarity between the data from the data structure 206 and one or more portions of the prompt 201. In some embodiments, an AI model can determine which data from the data structure 206 to add to the prompt 201 to generate the augmented input 219.

The augmented input 219 can include information reflecting the contents of the prompt 201, as well as additional information obtained from the data structure 206 and added by the retrieval component 211 by performing the RAG 210. In some embodiments, the retrieval component 211 can convert some or all of augmented input 219 from a human-readable representation into machine-readable instructions (e.g., one or more tokens) that can be provided as input to the model 260. In some embodiments, the additional information obtained by the retrieval component 211 from the data structure 206 as a part of performing the RAG 210 can be represented as one or more tokens. The one or more tokens representing the additional information can be appended to the natural language of the prompt 201. In some embodiments, the retrieval component 211 can convert the natural language of the prompt into one or more prompt tokens, and append the one or more tokens representing the additional information to the one or more prompt tokens to generate the augmented input 219. It is important to note that the augmented input 219 described here is provided as a whole the model 260. That is, in some embodiments, all of the augmented input 219 is processed simultaneously by the model 260. In some embodiments, some or all of the augmented input 219 can be processed sequentially by the model as instructed by the security posture module 251.

The retrieval component 211 receives the output from the model 260. In some embodiments, the posture validation component 230 receives the output from the model 260. In some embodiments, the security posture module 251 receives the output from the model 260. In some embodiments, the output from the model 260 can be, or include one or more generated features, such as the generated feature(s) 154 as described with reference to FIG. 1. In some embodiments one or more of the retrieval component 211, the posture validation component 230, or the security posture module 251 can extract one or more generated feature(s) from the output of the model 260.

The posture validation component 230 can determine (e.g., validate) that the generated feature(s) comply with the prompt 201. In some embodiments, the posture validation component 230 can determine that the generated feature(s) function properly within the larger security posture (e.g., security posture 170, described with reference to FIG. 1). In some embodiments, the posture validation component 230 can determine whether the generated feature(s) comply with one or more security threshold criteria pertaining to the organization or the security platform. In some embodiments, the posture validation component 230 can provide one or more of the generated feature(s), along with an evaluation criterion to an AI model to determine whether the generated features satisfy the evaluation criterion. In some embodiments, the evaluation criterion (e.g., a security threshold criterion) can be represented in natural language. In some embodiments, the evaluation criterion can be based on computer-executable coding syntax or conventions. In some embodiments, the evaluation criterion can be provided by one or more of the organization (e.g., a client organization 102) or the security platform (e.g., the security platform 120).

The security posture module 251 can control the elements and operations illustrated in the system 200. In some embodiments, the security posture module 251 can include one or more processing devices (e.g., a controller) that is operatively coupled to a memory storing computer-executable instructions (not illustrated). In some embodiments, the security posture module 251 can include one or more elements of the system 200, which may be shown distinctly in the system 200 for clarity and case of explanation. In some embodiments, the security posture module 251 can perform the function(s) of any of the elements or of the system 200 or the operations illustrated with respect to the system 200.

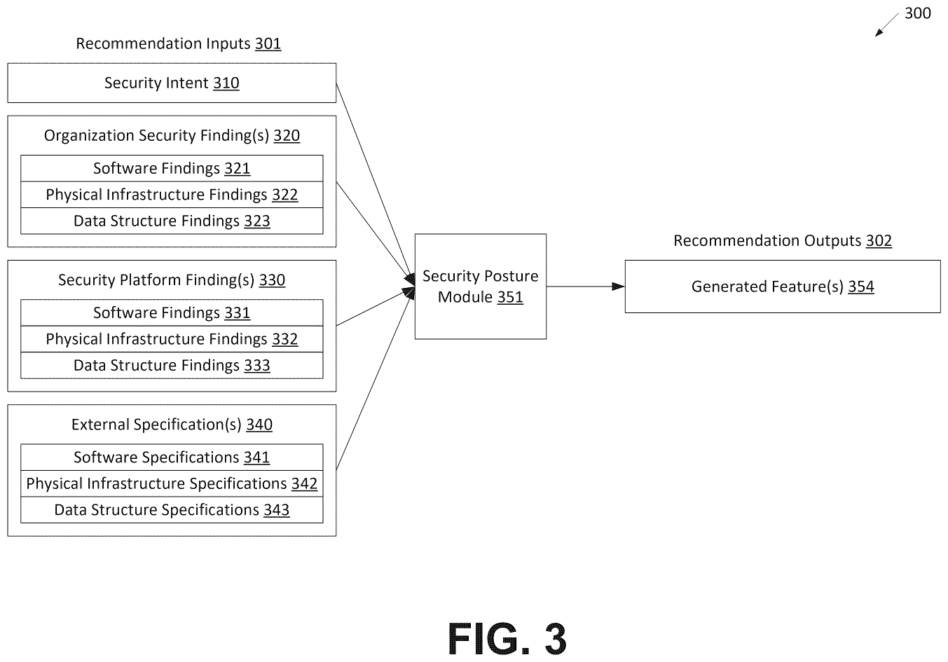

FIG. 3 is an example block diagram 300 of recommendation inputs 301 that are used to generate the recommendation outputs 302 by the security posture module 351, according to aspects of the disclosure. In some embodiments, the security posture module 351 can include or use one or more AI models (e.g., model 160 as described in FIG. 1) to generate the recommendation outputs 302 from the recommendation inputs 301.

The recommendation inputs 301 include a security intent 310 and one or more of organization security finding(s) 320, security platform finding(s) 330, or external specification(s) 340. In some embodiments, the security intent 310 can be used to by the security posture module 351 to generate the recommendation outputs 302. In some embodiments,

In some embodiments, the security intent 310 can be the same as or similar to the security intent 152 of FIG. 1.

In some embodiments, the organization security finding(s) 320 can be provided by the organization (e.g., a client organization 102). The organization security finding(s) 320 can include indications of current cybersecurity policies, vulnerabilities, cybersecurity threats, actual cybersecurity events (where the cybersecurity of the organization was compromised), computer networking configuration settings, identified misconfigurations, telemetry data, and the like. As illustrated in FIG. 3, the organization security finding(s) 320 can include software findings 321, physical infrastructure findings 322, and/or data structure findings 323.

In some embodiments, software findings can include one or more security features, polices, or the like that are implemented in software to protect an organization's computer environment from cyber threats. For example, software findings can include details about password requirements for the organization.

In some embodiments, physical infrastructure findings can include one or more security features, policies, or the like that are implemented in hardware, or in the physical word to protect an organization's computer environment from cyber threats. For example, physical infrastructure findings can include details about hardware encryption devices, or security badge polices for entering the workplace.

In some embodiments, data structure findings can include one or more security features, policies, or the like that are implemented in a data structure to protect an organization's data structure (and/or computer environment) from cyber threats. For example, data structure findings can include details about redundancy data for the data structure.

In some embodiments, the security posture module 351 can obtain one or more of the organization security finding(s) 320 from the organization. For example, the security posture module 351 can cause a RAG technique to be performed on a corpus of information that contains one or more of the organization security finding(s) 320.

In some embodiments, the security platform finding(s) 330 can be provided by the security platform (e.g., the security platform 120). The security platform finding(s) 330 can include collective cybersecurity findings (e.g. organization security findings 320) for multiple client organizations that use the security platform 120. In some embodiments, the security platform finding(s) 330 can represent aggregated and anonymized security findings for the multiple client organizations. In some embodiments, the security platform finding(s) 330 can include indications about the current cybersecurity policies, vulnerabilities, cybersecurity threats, actual security events (where the cybersecurity of the security platform 120 was compromised with respect to a client organization), or the like. In some embodiments, the security posture module 351 can obtain one or more of the security platform finding(s) 330 from the security platform. For example, the security posture module 351 can cause a RAG technique to be performed on a corpus of information that contains one or more of the security platform finding(s) 330. As illustrated in FIG. 3, and similarly described above, the security platform finding(s) 330 can include software findings 331, physical infrastructure findings 332, and/or data structure findings 333.

In some embodiments, the external specification(s) 340 can be provided by one or more of the organization (e.g., a client organization 102) or the security platform (e.g., the security platform 120). In some embodiments, the security posture module 351 can obtain the external specification(s) 340 from one or more of the organization, the security platform, or an external source. For example, the external specification(s) 340 can include proprietary or open-source cybersecurity specifications that are available publicly in full or in part. In another example, the security posture module 351 can cause a RAG technique to be performed on a corpus of information that contains one or more of the external specification(s) 340. As illustrated in FIG. 3, and similarly described above, the external specification(s) 340 can include software specifications 341, physical infrastructure specifications 342, or data structure specifications 343.

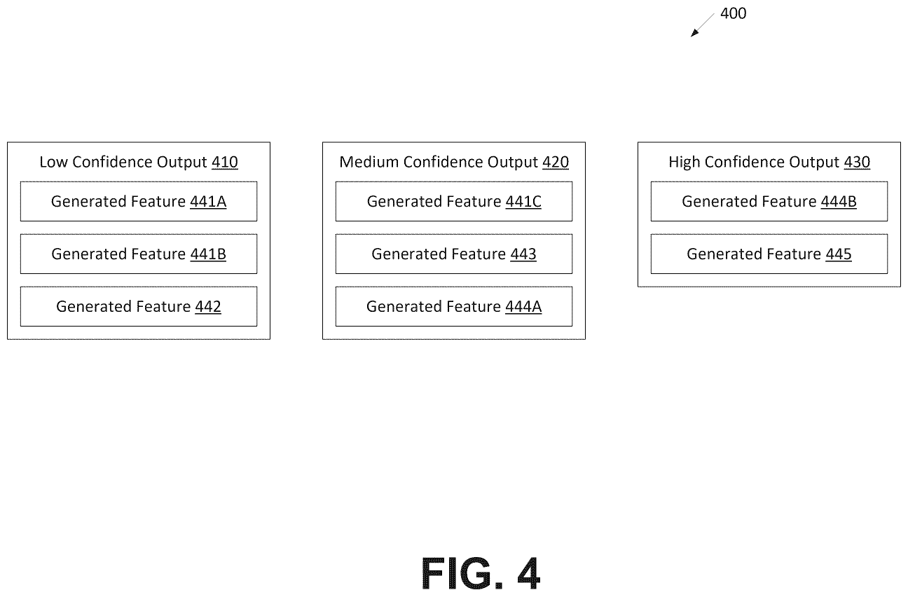

In some embodiments, the generated feature(s) 354 can be the same as or similar to the generated features 154 of FIG. 1. As similarly described above, in some embodiments, the security posture module 351 can generate multiple of the generated feature(s) 354 for the same security intent (e.g., the security intent 310). In some embodiments, the multiple of the generated feature(s) 354 can include different generated features, as well as variations of generated features. Additional details are described below with reference to FIG. 4.

FIG. 4 is an example block diagram of outputs 400 from a security posture module, according to aspects of of the disclosure. The outputs 400 from the security posture module, such as a security posture module 151 as described in FIG. 1, can be organized by a level of confidence that the generated feature (e.g., the output) pertains to the provided prompt (e.g., the input).

In some embodiments, the confidence level (e.g., low confidence output 410, medium confidence output 420, or high confidence output 430) for each output 400 can be determined by the security posture module 151. In some embodiments, the model used by the security posture module 151 (e.g., model 160 as described in FIG. 1) can generate confidence data along with the generated feature.

It can be appreciated that the block diagram of outputs 400 are illustrative, and that additional groupings are considered. For example, outputs 400 may be organized into any of two or more groupings (in addition to the illustrated three groupings). In some embodiments, the threshold between the groupings

The outputs 400 are generated based on an input, such as a prompt describing a security intent in natural language. In some embodiments, the outputs 400 are generated from multiple prompts. In some embodiments, the outputs 400 are generated from a single prompt. In some embodiments, the generated features included in the outputs 400 can include one or more of an organization policy, a security platform policy, an account management policy, a virtual network policy, a physical network policy, or the like.

In some embodiments, the outputs 400 can include variations of a generated feature (e.g., generated feature 441A, generated feature 441B, and generated feature 441C). For example, given a particular input prompt, the outputs 400 can include a first variation of an organization policy and a second variation of an organization policy as generated features. In some embodiments, the outputs 400 can include different generated features (e.g., generated feature 442 and generated feature 443). For example, given a particular input prompt, the outputs 400 can include an organization policy, and a security platform policy as generated features. In some embodiments, the outputs 400 can include variations of a generated feature, and different generated features. For example, given a particular input prompt, the outputs 400 can include a first variation of a first organization policy, a second variation of the first organization policy, a second organization policy, and an account management policy.

In the illustrated example, the outputs 400 include generated feature 441A, generated feature 441B, and generated feature 442 grouped into the low confidence output 410. In some embodiments, the low confidence output 410 can indicate one or more of a low correspondence between the output (e.g., the generated feature) and the input (e.g., the natural language prompt), a low confidence that the output will perform as intended, a low confidence that the output will function in the security posture, or the like.

In the illustrated example, the outputs 400 include generated feature 441C, generated feature 443, and generated feature 444A grouped into the medium confidence output 420. In some embodiments, the medium confidence output 420 can indicate one or more of a moderate correspondence between the output (e.g., the generated feature) and the input (e.g., the natural language prompt), a medium confidence that the output will perform as intended, a medium confidence that the output will function in the security posture, or the like. In some embodiments, the difference between a low confidence output 410 and a medium confidence output 420 can be defined by a threshold condition.

In the illustrated example, the outputs 400 include generated feature 444B, and generated feature 445 grouped into the high confidence output 430. In some embodiments, the low confidence output 410 can indicate one or more of a high correspondence between the output (e.g., the generated feature) and the input (e.g., the natural language prompt), a high confidence that the output will perform as intended, a high confidence that the output will function in the security posture, or the like. In some embodiments, the difference between a high confidence output 430 and a medium confidence output 420 can be defined by a threshold condition.

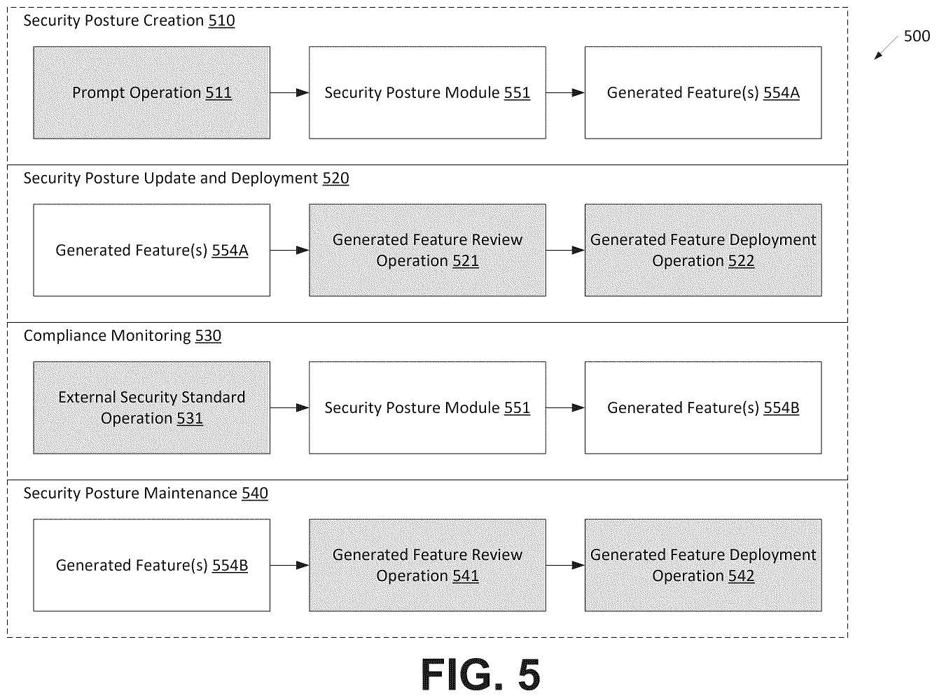

FIG. 5 illustrates an example block diagram flow 500 for security posture generation using an artificial intelligence (AI) model, according to aspects of the disclosure. In the block diagram flow 500, operations are illustrated with gray blocks, and modules or components are illustrated with white blocks.

During security posture creation 510, a prompt operation 511 is performed to obtain a natural language description of a security intent. The natural language description of the security intent is provided to the security posture module 551 (e.g., the security posture module 151 of FIG. 1). In some embodiments, the prompt operation 511 is performed via a GUI provided to a client device (e.g., client device 110 of FIG. 1) associated with an organization (e.g., client organization 102 of FIG. 1) using a security platform (e.g., security platform 120 of FIG. 1). The security posture module 551 generates the generated features 554A (e.g., generated features 154 of FIG. 1, or one of outputs 400 of FIG. 4) based on the input received from the prompt operation 511.

During security posture update and deployment 520, a generated feature review operation 521 is performed on the generated feature(s) 554A. During the generated feature review operation 521, the generated feature(s) 554A can be reviewed for completeness, accuracy, functionality, or the like. In some embodiments, one or more security threshold criterion can be used to evaluate the generated feature(s) 554A at the generated feature review operation 521. Generated feature(s) 554A that satisfy the criterion, or are otherwise approved, can be deployed during the generated feature deployment operation 522. In some embodiments, the generated feature review operation 521 is performed via a GUI provided to a client device associated with an organization. In some embodiments, some or all of the generated feature review operation 521 is performed by one or more of an algorithm, an AI model, or the like.

After the generated feature review operation 521, the generated feature deployment operation 522 can be performed. In some embodiments, during the generated feature deployment operation 522, one or more of the generated feature(s) 554A that were approved during the generated feature review operation 521 can be implemented in a security posture for the organization.

During compliance monitoring 530, an external security specification operation 531 is performed to obtain a natural or technical language description of an external security specification (e.g., an open-source privacy specification). The description of the external security specification is provided to the security posture module 551. In some embodiments, the prompt operation 511 is performed via a GUI provided to a client device associated with an organization using the security platform. The security posture module 551 generates the generated features 554B based on the input received from the external security specification operation 531.

During security posture maintenance 540, a generated feature review operation 541 is performed on the generated feature(s) 554B. During the generated feature review operation 541, the generated feature(s) 554B can be reviewed for completeness, accuracy, functionality, or the like. In some embodiments, one or more security threshold criterion can be used to evaluate the generated feature(s) 554B at the generated feature review operation 521. Generated feature(s) 554B that satisfy the criterion, or are otherwise approved, can be deployed during the generated feature deployment operation 542. In some embodiments, the generated feature review operation 541 is performed via a GUI provided to a client device associated with an organization. In some embodiments, some or all of the generated feature review operation 541 is performed by one or more of an algorithm, an AI model, or the like.

After the generated feature review operation 541, the generated feature deployment operation 542 can be performed. In some embodiments, during the generated feature deployment operation 542, one or more of the generated feature(s) 554A that were approved during the generated feature review operation 541 can be implemented in a security posture for the organization.

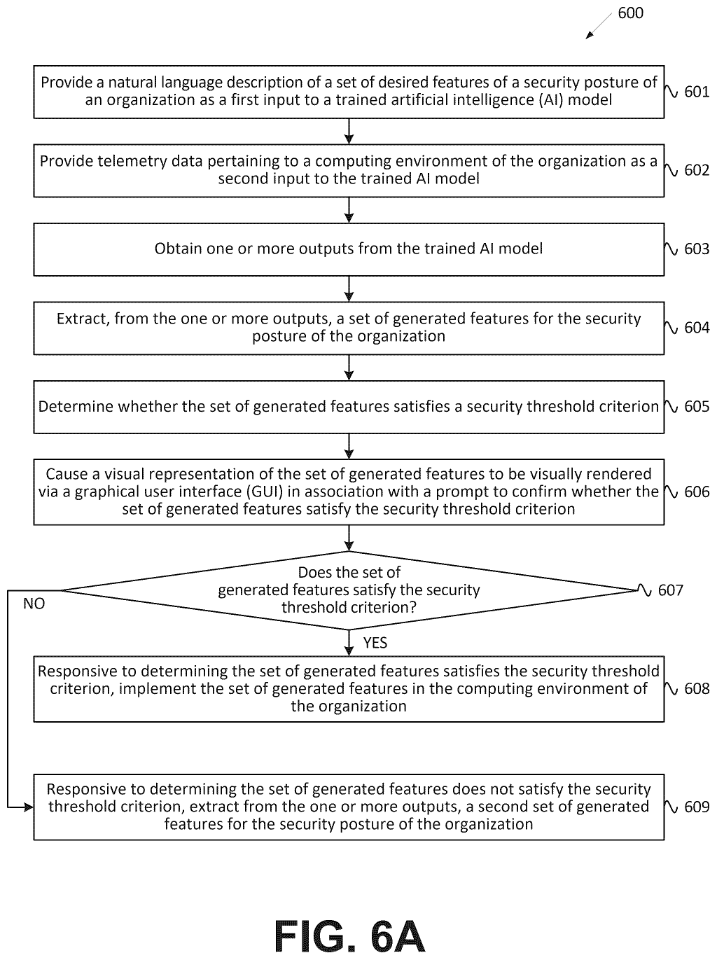

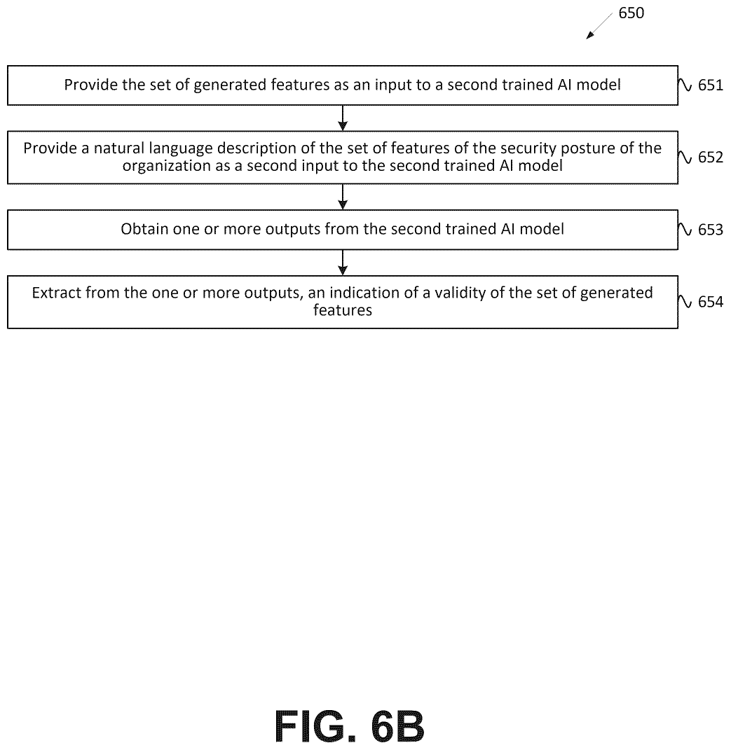

FIG. 6A illustrates an example method 600 for security posture generation using an AI model, according to aspects of the disclosure. The method 600 can be performed by processing logic that can include hardware (circuitry, dedicated logic, etc.), software (e.g., instructions run on a processing device), or a combination thereof. In one implementation, some, or all of the operations of the method 600 can be performed by one or more components of system 100 of FIG. 1. In some implementations, some, or all of the operations of the method 600 can be performed by the security posture module 151 as described above.

At operation 601, the processing logic performing the method 600 provides a natural language description of a set of desired features of a security posture of an organization as a first input to a trained artificial intelligence (AI) model. In some embodiments, the natural language description of the set of features of the security posture of the organization can include a corpus reflecting an external security specification. In some embodiments, the natural language description of the set of features of the security posture of the organization can include one or more of organization characteristics, or security platform characteristics.

At operation 602, the processing logic provides telemetry data pertaining to a computing environment of the organization as a second input to the trained AI model.

At operation 603, the processing logic obtains one or more outputs from the trained AI model.

At operation 604, the processing logic extracts, from the one or more outputs, a set of generated features for the security posture of the organization.

At operation 605, the processing logic determines whether the set of generated features satisfies a security threshold criterion.

At operation 606, the processing logic causes a visual representation of the set of generated features to be visually rendered via a graphical user interface (GUI) in association with a prompt to confirm whether the set of generated features satisfy the security threshold criterion.

At operation 607, the processing logic determines whether the set of generated features satisfies the security threshold criterion.

At operation 608, responsive to determining the set of generated features satisfies the security threshold criterion, the processing logic implements the set of generated features in the computing environment of the organization.

At operation 609, responsive to determining the set of generated features does not satisfy the security threshold criterion, the processing logic extracts from the one or more outputs, a second set of generated features for the security posture of the organization.

FIG. 6B illustrates an example method 650 for security posture generation using an AI model, according to aspects of the disclosure. The method 650 can be performed by processing logic that can include hardware (circuitry, dedicated logic, etc.), software (e.g., instructions run on a processing device), or a combination thereof. In one implementation, some, or all of the operations of the method 650 can be performed by one or more components of system 100 of FIG. 1. In some implementations, some, or all of the operations of the method 650 can be performed by the security posture module 151 as described above. In some embodiments, some, or all of the operations 651-660 of the method 650 can be performed as a part of the operation 605 of FIG. 6A.

At operation 651, the processing logic provides the set of generated features as an input to a second trained AI model.

At operation 652, the processing logic provides a natural language description of the set of features of the security posture of the organization as a second input to the second trained AI model.

At operation 653, the processing logic obtains one or more outputs from the second trained AI model.

At operation 654, the processing logic extracts from the one or more outputs, an indication of a validity of the set of generated features.

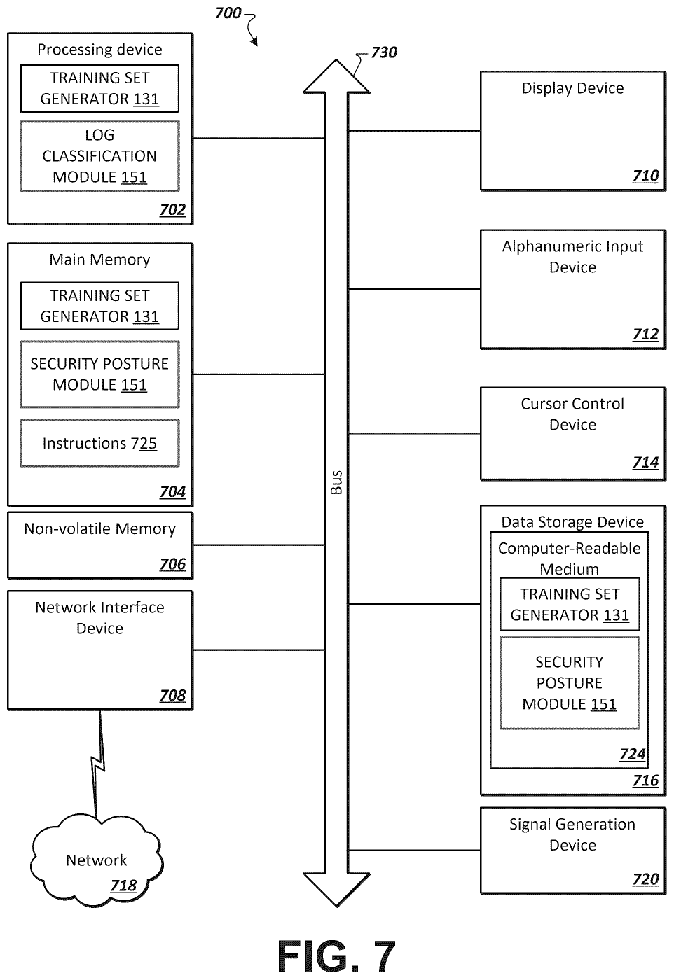

FIG. 7 is a block diagram illustrating an example of a computer system 700, according to aspects of the disclosure. The computer system 700 can correspond to security platform 120 and/or client devices 102A-N, described in FIG. 1. Computer system 700 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 700 includes a processing device 702 (e.g., a processor), a main memory 704 (e.g., read-only memory (ROM), flash memory, dynamic random access memory (DRAM) such as synchronous DRAM (SDRAM), double data rate (DDR) SDRAM, or DRAM (RDRAM), etc.), a non-volatile memory 706 (e.g., flash memory, static random access memory (SRAM), etc.), and a data storage device 716, which communicate with each other via a bus 730. In some embodiments, the main memory 704 can be a non-transitory computer readable storage medium.

Processing device 702 represents one or more general-purpose processing devices such as a microprocessor, central processing unit, or the like. More specifically, processing device 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 can also be one or more special-purpose processing devices such as an application specific integrated circuit (ASIC), a field programmable gate array (FPGA), a digital signal processor (DSP), network processor, or the like. The processing device 702 is configured to execute network interface device 708 (e.g., for synchronizing data between platforms) for performing the operations discussed herein. The processing device 702 can be configured to execute instructions 725 stored in main memory 704. Non-volatile memory 706 can store the instructions 725 when they are not being executed, and can store additional system data that can be accessed by processing device 702.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 718 (e.g., a speaker).

The data storage device 716 can include a computer-readable storage medium 724 (e.g., a non-transitory machine-readable storage medium) on which is stored one or more sets of instructions 725 (e.g., for generating variations of a translated audio portion) embodying any one or more of the methodologies or functions described herein. The instructions can also reside, completely or at least partially, within the main memory 704 and/or within the processing device 702 during execution thereof by the computer system 700, the main memory 704 and the processing device 702 also constituting machine-readable storage media. The instructions can further be transmitted or received over a network 720 via the network interface device 708.

While the computer-readable storage medium 724 (non-transitory computer-readable storage medium) is illustrated in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a specific feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the specific features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specific by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
providing a natural language description of a set of desired features of a security posture of an organization as a first input to a trained artificial intelligence (AI) model;
providing telemetry data pertaining to a computing environment of the organization as a second input to the trained AI model;
obtaining one or more outputs from the trained AI model; and
extracting, from the one or more outputs, a set of generated features for the security posture of the organization.

2. The method of claim 1, further comprising:
determining whether the set of generated features satisfies a security threshold criterion; and
responsive to determining the set of generated features satisfies the security threshold criterion,
implementing the set of generated features in the computing environment of the organization.

3. The method of claim 1, further comprising:
determining whether the set of generated features satisfies a security threshold criterion based on a security specification; and
responsive to determining that the set of generated features does not satisfy the security specification,
adding one or more additional features to the set of generated features.

4. The method of claim 1, further comprising:
providing the set of generated features as an input to a second trained AI model;
obtaining one or more outputs from the second trained AI model; and
extracting from the one or more outputs, an indication of a validity of the set of generated features.

5. The method of claim 4, further comprising:
providing the natural language description of the set of features of the security posture of the organization as a second input to the second trained AI model.

6. The method of claim 1, further comprising:
causing a visual representation of the set of generated features to be visually rendered via a graphical user interface (GUI) associated with a prompt to confirm whether the set of generated features satisfy a security threshold criterion.

7. The method of claim 1, further comprising:
determining whether the set of generated features satisfies a security threshold criterion; and
responsive to determining the set of generated features does not satisfy the security threshold criterion, extracting, from the one or more outputs, a second set of generated features for the security posture of the organization.

8. A system comprising:
a memory; and
one or more processing devices operatively coupled to the memory, the one or more processing devices to perform operations comprising:
providing a natural language description of a set of desired features of a security posture of an organization as a first input to a trained artificial intelligence (AI) model;
providing telemetry data pertaining to a computing environment of the organization as a second input to the trained AI model;
obtaining one or more outputs from the trained AI model; and
extracting, from the one or more outputs, a set of generated features for the security posture of the organization.

9. The system of claim 8, the operations further comprising:
determining whether the set of generated features satisfies a security threshold criterion; and
responsive to determining the set of generated features satisfies the security threshold criterion,
implementing the set of generated features in the computing environment of the organization.

10. The system of claim 8, the operations further comprising:
determining whether the set of generated features satisfies a security threshold criterion based on a security specification; and
responsive to determining that the set of generated features does not satisfy the security specification,
adding one or more additional features to the set of generated features.

11. The system of claim 8, the operations further comprising:
providing the set of generated features as an input to a second trained AI model;
obtaining one or more outputs from the second trained AI model; and
extracting from the one or more outputs, an indication of a validity of the set of generated features.

12. The system of claim 11, the operations further comprising:
providing the natural language description of the set of features of the security posture of the organization as a second input to the second trained AI model.

13. The system of claim 8, the operations further comprising:
causing a visual representation of the set of generated features to be visually rendered via a graphical user interface (GUI) associated with a prompt to confirm whether the set of generated features satisfy a security threshold criterion.

14. The system of claim 8, the operations further comprising:
responsive to determining the set of generated features do not satisfy a security threshold criterion, extracting, from the one or more outputs, a second set of generated features for the security posture of the organization.

15. A non-transitory computer-readable storage medium comprising instructions for a server that, when executed by one or more processing devices, cause the one or more processing devices to perform operations comprising: providing a natural language description of a set of desired features of a security posture of an organization as a first input to a trained artificial intelligence (AI) model;
providing telemetry data pertaining to a computing environment of the organization as a second input to the trained AI model;
obtaining one or more outputs from the trained AI model; and
extracting, from the one or more outputs, a set of generated features for the security posture of the organization.

16. The non-transitory computer-readable storage medium of claim 15, the operations further comprising:
determining whether the set of generated features satisfies a security threshold criterion; and
responsive to determining the set of generated features satisfies the security threshold criterion,
implementing the set of generated features in the computing environment of the organization.

17. The non-transitory computer-readable storage medium of claim 15, the operations further comprising:
determining whether the set of generated features satisfies a security threshold criterion based on a security specification; and
responsive to determining that the set of generated features does not satisfy the security specification,
adding one or more additional features to the set of generated features.

18. The non-transitory computer-readable storage medium of claim 15, the operations further comprising:
providing the set of generated features as an input to a second trained AI model;
obtaining one or more outputs from the second trained AI model; and
extracting from the one or more outputs, an indication of a validity of the set of generated features.

19. The non-transitory computer-readable storage medium of claim 18, the operations further comprising:
providing the natural language description of the set of features of the security posture of the organization as a second input to the second trained AI model.

20. The non-transitory computer-readable storage medium of claim 15, the operations further comprising:
causing a visual representation of the set of generated features to be visually rendered via a graphical user interface (GUI) associated with a prompt to confirm whether the set of generated features satisfy a security threshold criterion.
